(19) United States
(12) Patent Application Publication
(10) Pub. No.: US 2012/0142887 A1
(43) Pub. Date: Jun. 7, 2012

(54) CROSSLINKED POLYAMIDES

(75) Inventors: Philippe Desbois, Edingen-Neckarhausen (DE); Dietrich Scherzer, Neustadt (DE); Andreas Wollny, Ludwigshafen (DE); Andreas Radtke, Mannheim (DE)

(73) Assignee: BASF SE, Ludwigshafen (DE)

(21) Appl. No.: 13/308,707

(22) Filed: Dec. 1, 2011

Related U.S. Application Data
(60) Provisional application No. 61/419,257, filed on Dec. 3, 2010.

(51) Int. Cl. C08G 69/16

(52) U.S. Cl. 528/325

(57) ABSTRACT

A process for crosslinking polyamides by reacting a compound of the general formula R¹R²C═CR³—X in which R¹, R² and R³ are each independently hydrogen or an organic radical with a lactam A at a temperature of (−30) to 150° C., and then reacting with a lactam B, a catalyst and an activator at a temperature of 40 to 240° C.

The present invention relates to a process for crosslinking polyamides.

Crosslinked polyamides are not preparable via the standard polymerization method. Since the polymerization processes require long residence times and also high temperatures, it is no longer possible to discharge such polymers due to the very high viscosity, and plants operated in such a way would block very rapidly.

The sole means of obtaining crosslinked polyamides is the use of what is called the postcross-linking method, where an additive is added during the polymerization or the compounding. After injection molding of the polyamide part, this additive is induced via an external stimulus by radiation to react with the polyamide chain, for example in order to crosslink it.

The anionic polymerization of nylon-6 is known and is used commercially. In that case, the polymerization is performed directly in a mold. Because the polymerization is very rapid, it can be performed at a relatively low temperature (80-200° C.). The use of monomer instead of polymer to fill the mold allows attainment of a higher filling level (80-90%). Such polymerization requires the addition of a catalyst (sodium and potassium derivatives) and produces linear polyamide chains (thermoplastics).

DE-A-14 20 241 discloses a process for preparing linear polyamide chains by addition of KOH as a catalyst and 1,6-bis-(N,N-dibutylureido)hexane as an activator by anionic polymerization of lactams.

Polyamide [polyamides], Kunststoff Handbuch [Plastics handbook] Vol. 3/4, ISBN 3-446-16486-3, 1998, Carl Hanser Verlag, 49-52 discloses activated anionic lactam polymerization. This describes the use of sodium caprolactamate as a catalyst combined with acyllactam derivatives for preparation of linear polyamides.

Macromolecules, Vol. 32, 23 (1999) page 7726 discloses activated anionic lactam polymerization. This describes the use of sodium caprolactamate as a catalyst combined with N,N′-hexamethylenebis(2-oxo-1-azepanylcarboxamide) for preparation of linear polyamides.

The polymer obtained is linear, and it therefore has the inherent disadvantages of thermoplastics compared to thermosets: higher creep, lower resistance to organic solvents.

Charlesby, A., 1953, Nature 171, 167 and Deeley, C. W., Woodward, A. E., Sauer, J. A., 1957, J. Appl. Phys. 28, 1124-1130 disclose irradiation for crosslinking of injected-molded thermoplastics such as polyamides.

A disadvantage of this process is the postcrosslinking with a radiation apparatus.

It was therefore an object of the present invention to remedy the aforementioned disadvantages.

Accordingly, a novel and improved process has been found for crosslinking of polyamides, which comprises reacting a compound of the general formula R¹R²C═CR³—X in which R¹, R² and R³ are each independently hydrogen or an organic radical with a lactam A at a temperature of (−30) to 150° C. and then reacting with a lactam B, a catalyst and an activator at a temperature of 40 to 240° C.

The process according to the invention can be performed as follows:

The compound of the general formula R¹R²C═CR³—X can be reacted with a lactam A at a temperature of (−30) to 150° C., preferably 0 to 80° C., more preferably 20 to 50° C., and a pressure of 0.1 to 10 bar, preferably 0.5 to 5 bar, more preferably atmospheric pressure (standard pressure) in a solvent A. The reaction product, with or without further purification, preferably after removal of the solvent A under reduced pressure at 0.001 to 0.5 bar, preferably 0.01 to 0.3 bar, more preferably 0.1 to 0.2 bar, and a temperature of 5 to 200° C., preferably 10 to 180° C., more preferably 20 to 150° C., can be mixed with a lactam B, a catalyst and an activator and reacted at a temperature of 40 to 240° C., preferably 70 to 180° C., more preferably 100 to 170° C., and a pressure of 0.1 to 10 bar, preferably 0.5 to 5 bar, more preferably atmospheric pressure (standard pressure), especially without solvent.

The lactam A can be mixed at a temeprature of 5 to 200° C., preferably 10 to 180° C., more preferably 20 to 150° C., and a pressure of 0.1 to 10 bar, preferably 0.5 to 5 bar, more preferably atmospheric pressure (standard pressure), with a lactam B, a catalyst and an activator at a temperature of 40 to 240° C., preferably 70 to 180° C., more preferably 100 to 170° C., and a pressure of 0.1 to 10 bar, preferably 0.5 to 5 bar, more preferably atmospheric pressure (standard pressure), especially without solvent.

The substituents R¹, R², R³ and X in the general formula R¹R²C═CR³—X are each defined as follows:

R¹, R² and R³ are each independently
hydrogen or an organic radical, preferably hydrogen.

Preferred organic radicals are the following radicals:
C₁-C₈-alkyl, preferably C₁-C₄-alkyl such as methyl, ethyl, n-propyl, isopropyl, n-butyl, iso-butyl, sec-butyl and tert-butyl, more preferably C₁-C₂-alkyl such as methyl and ethyl, especially methyl,
singly to triply by C₁-C₄-alkyl such as methyl, ethyl, n-propyl, isopropyl, n-butyl, isobutyl, sec-butyl and tert-butyl, more preferably C₁-C₂-alkyl such as methyl and ethyl, especially methyl, amino (—NH₂), aryl such as phenyl, —NC═O, —COCl, —COBr, —COOH and carboxylic anhydride,
aryl such as phenyl and naphthyl,
carbonyl and
vinyl.

X is
—NC═O, —COCl, —COBr, —COOH, carboxylic anhydride and —COOR⁴, where R⁴ is C₁-C₁₂-alkyl, preferably C₁-C₄-alkyl such as methyl, ethyl, n-propyl, isopropyl, n-butyl, isobutyl, sec-butyl and tert-butyl, more preferably C₁-C₂-alkyl such as methyl and ethyl, especially methyl, preferably —NC═O and —COCl, more preferably —COCl.

Suitable compounds of the general formula R¹R²C═CR³—X are, for example, butenoyl chloride, propenoyl chloride, 2-propenoyl bromide, vinyl isocyanate and acrylic acid, preferably 2-propenoyl chloride and 2-propenoyl bromide, more preferably 2-propenoyl chloride.

Suitable lactams A are amino-substituted lactams such as aminocaprolactam, aminopiperidone, aminopyrrolidone, aminolauryllactam or mixtures thereof, preferably aminocaprolactam, aminopyrrolidone or mixtures thereof, more preferably aminocaprolactam.

Suitable solvents A are dimethyl sulfoxide, methyl chloride, methylene chloride, dioxane, tetrahydrofuran, acetonitrile, chloroform, tetrahydropyran, N-methylpyrrolidone, N-ethylpyrrolidone, dimethylformamide, caprolactam, lauryllactam, methanol, ethanol, n-propanol, isopropanol or mixtures thereof, preferably dimethyl sulfoxide, acetonitrile, chloroform, methyl chloride, methylene chloride, tetrahydrofuran or mixtures thereof, more preferably acetonitrile, chloroform.

Suitable lactams B are caprolactam, piperidone, pyrrolidone, lauryllactam or mixtures thereof, preferably caprolactam, lauryllactam or mixtures thereof, more preferably caprolactam or lauryl-lactam. In addition to copolymers formed from different lactams as monomers, it is also possible to use a lactone such as caprolactone as a comonomer. The amount of a lactone as a comonomer should generally not exceed 40% by weight based on the overall monomer; the proportion of lactone is preferably not more than 10% by weight based on the overall monomer; more preferably, no lactone is used as a comonomer.

The anionic polymerization can preferably be performed in the presence of an activator. An activator is understood to mean a lactam N-substituted by electrophilic radicals or a precursor thereof which, together with a lactam, forms a lactam N-substituted by electrophilic radicals in situ.

The amount of activator defines the number of growing chains, since it is the starting member in the reaction. Suitable electrophilic radicals are radicals which arise from reactions of —NC═O, —COCl, —COBr or carboxylic anhydrides with lactams.

Suitable activators are aliphatic diisocyanates such as butylene diisocyanate, hexamethylene diisiocyanate, octamethylene diisocyanate, decamethylene diisocyanate, undodecamethylene diisocyanate, dodecamethylene diisocyanate, and also aromatic diisocyanates such as tolyl diisocyanate, isophorone diisocyanate, 4,4′-methylenebis(phenyl isocyanate), 4,4′-methylenebis(cyclohexyl isocyanate), or polyisocyanates such as isocyanurates of hexamethylene diisocyanate, Basonat® HI 100 from BASF SE, allophanates such as ethyl allophanate or mixtures thereof, preferably hexamethylene diisocyanate, isophorone diisocyanate, more preferably hexamethylene diisocyanate. The diisocyanates can be replaced by monoisocyanates.

Alternatively suitable as activators diacid halide are suitable aliphatic diacid halide such as butylene diacid chloride, butylene diacid bromide, hexamethylene diacid chloride, hexamethylene diacid bromide, octamethylene diacid chloride, octamethylene diacid bromide, decamethylene diacid chloride, decamethylene diacid bromide, dodecamethylene diacid chloride, dodecamethylene diacid bromide, and also aromatic diacid halide such as tolyl diacid chloride, tolylmethylene diacid bromide, isophorone diacid chloride, isophorone diacid bromide, 4,4′-methylenebis(phenyl acid chloride), 4,4′-methylenebis(phenyl acid bromide), 4,4′-methylenebis(cyclohexyl acid chloride), 4,4′-methylenebis(cyclohexyl acid bromide) or mixtures thereof, preferably hexamethylene diacid chloride, hexamethylene diacid bromide or mixtures thereof, more preferably hexamethylene diacid chloride. The diacid halides may be replaced by monoacid halides.

Preference is given to performing the anionic polymerization in the presence of a catalyst. Such catalysts are known, for example, from Polyamide, Kunststoff Handbuch Vol. 3/4, ISBN 3-446-16486-3, 1998, Carl Hanser Verlag, 49-52. This describes, inter alia, the use of sodium caprolactamate as a catalyst combined with acyllactam derivatives.

Suitable catalysts are sodium caprolactamate, potassium caprolactamate, caprolactam magnesium bromide, caprolactam magnesium chloride, magnesium biscaprolactamate, sodium hydride, sodium, sodium hydroxide, sodium methoxide, sodium ethoxide, sodium propoxide, sodium butoxide, potassium hydride, potassium, potassium hydroxide, potassium methoxide, potassium ethoxide, potassium propoxide, potassium butoxide, preferably sodium hydride, sodium, sodium caprolactamate, more preferably sodium caprolactamate (Bruggolen® C 10, a solution of 18% by weight of sodium caprolactamate in caprolactam).

The molar ratio of compound of the general formula R¹R²C═CR³—X to the lactam A can be varied within wide limits, and is generally 0.01:1 to 100:1, preferably 0.1:1 to 10:1, more preferably 0.5:1 to 1.5:1.

The molar ratio of the solvent A to the compound of the general formula R¹R²C═CR³—X can be varied within wide limits, and is generally 200:1 to 0:1, preferably 100:1 to 0.5:1, more preferably 50:1 to 1:1.

The molar ratio of the solvent A to the lactam A can be varied within wide limits, and is generally 200:1 to 0.5:1, preferably 50:1 to 1:1, more preferably 10:1 to 1:1.

The molar ratio of lactam B to lactam A can be varied within wide limits, and is generally 1:1 to 10 000:1, preferably 5:1 to 5000:1, more preferably 10:1 to 3000:1.

The molar ratio of lactam B to the catalyst can be varied within wide limits, and is generally 1:1 to 10 000:1, preferably 10:1 to 1000:1, more preferably 20:1 to 300:1.

The molar ratio of activator to the catalyst can be varied within wide limits, and is generally 0.01:1 to 10:1, preferably 0.1:1 to 5:1, more preferably 0.2:1 to 2:1.

The process according to the invention can be used to prepare crosslinked polyamides from any polyamides, for example, nylon-3, nylon-4, nylon-5, nylon-6, nylon-7, nylon-8, nylon-9, nylon-10, nylon-11, nylon-12, nylon-13, nylon-14, nylon-15, nylon-16, nylon-17 and nylon-18, or copolyamides such as nylon-4,6, nylon-5,6, nylon-4,5, nylon-6,7, nylon-6,8, nylon-6,9, nylon-6,10, nylon-6,12, nylon-4,12, nylon-4,10, nylon-5,10, nylon-5,12, preferably nylon-6, nylon-12, nylon-4,6, nylon-5,6, nylon-4,12, nylon-5,12, particularly preferably nylon-6 and nylon-12, especially nylon-6.

The crosslinked polyamides prepared in accordance with the invention are suitable as a material for production of wind turbines, such as rotor blades and cladding of wind turbine towers, automobile parts such as fenders, bumpers, shock absorbers, chassis cladding, dashboards, the interior of passenger cells.

### EXAMPLES

Preparation of the Starting Materials

### Example I

### Preparation of N-(2-oxoazepan-3-yl)propenamide

8 ml (98.46 mmol) of acryloyl chloride and 12.8 g (100 mmol) of α-amino-ε-caprolactam (preparable according to WO-A-2005/123 669, Example 7) were stirred in 300 ml of anhydrous chloroform under nitrogen in a closed round-bottomed flask at 40° C. for 1 h, the chloroform was evaporated at 100 mbar and 40° C., the resulting powder was dissolved twice with 70 ml each time of acetonitrile at 70° C. and cooled to room temperature, and the crystalline product was filtered off. This gave 13.7 g (75.27 mmol) (76.4%) of powder.

Examples 1 to 4 and Comparative Examples A to C

Synthesis of nylon-6 by anionic polymerization of ε-caprolactam

All polymerization reactions were conducted at 140° C. while stirring in a dry argon atmosphere in a 50-ml glass calorimeter reactor which was closed with a grease-free Rotaflo tap and provided with a thermocouple and a glass break-seal tube.

### Example 1

5.2 g (49.1 mmol) of ε-caprolactam, 1 g (5.49 mmol) of N-(2-oxoazepan-3-yl)propenamide and 0.9 g (1.127 mmol) of Bruggolen® C 10 (17% w/w ε-caprolactamate in ε-caprolactam) were mixed in the reactor at 140° C., and 0.41 g (0.83 mmol) of Bruggolen® C20 (80% w/w of blocked diisocyanate in ε-caprolactam) into the glass break-seal tube and heated at 140° C. On attainment of 140° C., the molten Bruggolen® C20 was injected into the molten mixture with the aid of a break-seal system, and the polymerization was left to stand for 20 minutes and then quenched by cooling the reactor in water (10° C.). This gave 7.5 g of nylon-6 in solid form.

1 g of the polymer obtained was poured while stirring into 50 ml of hexafluoroisopropanol (HFIP) at room temperature. After 10 h, a gel-like structure was obtained. After filtration, the polymer was recovered on the filter, while no polymer was detected in the filtrate after evaporative concentration, from which it is clear that the N6 was insoluble in HFIP and was fully crosslinked. 0.97 g was obtained in solid form.

The crystallinity was conducted by DSC analysis with the Q 2000 instrument from Waters GmbH. The starting weight was 8.5 mg, the heating or cooling rate 20 K/min. The sample was analyzed to ISO 11357-7. According to this, the crystallinity was 0%.

The degree of swelling of the polyamide obtained was 2.

### Example 2

5.94 g (52.5 mmol) of ε-caprolactam, 0.25 g (1.37 mmol) of N-(2-oxoazepan-3-yl)propenamide and 0.9 g (1.127 mmol) of Bruggolen® C 10 (17% w/w ε-caprolactamate in ε-caprolactam) were mixed in the reactor at 140° C., and 0.41 g (0.83 mmol) of Bruggolen® C20 (80% w/w of blocked diisocyanate in ε-caprolactam) into the glass break-seal tube and heated at 140° C. On attainment of 140° C., the molten Bruggolen® C20 was injected into the molten mixture with the aid of a break-seal system, and the polymerization was left to stand for 20 minutes and then quenched by cooling the reactor in water (10° C.). This gave 7.6 g of nylon-6 in solid form.

1 g of the polymer obtained was poured while stirring into 50 ml of hexafluoroisopropanol (HFIP) at room temperature. After 10 h, a gel-like structure was obtained. After filtration, the polymer was recovered on the filter, while no polymer was detected in the filtrate after evaporative concentration, from which it is clear that the N6 was insoluble in HFIP and was fully crosslinked. 0.98 g was obtained in solid form.

The crystallinity was conducted by DSC analysis with the Q 2000 instrument from Waters GmbH. The starting weight was 8.5 mg, the heating or cooling rate 20 K/min. The sample was analyzed to ISO 11357-7. According to this, the crystallinity was 21%.

The degree of swelling of the polyamide obtained was 23.

### Example 3

6.13 g (54.1 mmol) of ε-caprolactam, 0.065 g (0.357 mmol) of N-(2-oxoazepan-3-yl)propenamide and 0.9 g (1.127 mmol) of Bruggolen® C 10 (17% w/w ε-caprolactamate in ε-caprolactam) were mixed in the reactor at 140° C., and 0.41 g (0.83 mmol) of Bruggolen® C20 (80% w/w of blocked diisocyanate in ε-caprolactam) into the glass break-seal tube and heated at 140° C. On attainment of 140° C., the molten Bruggolen® C20 was injected into the molten mixture with the aid of a break-seal system, and the polymerization was left to stand for 20 minutes and then quenched by cooling the reactor in water (10° C.). This gave 7.6 g of nylon-6 in solid form.

1 g of the polymer obtained was poured while stirring into 50 ml of hexafluoroisopropanol (HFIP) at room temperature. After 10 h, a gel-like structure was obtained. After filtration, the polymer was recovered on the filter, while no polymer was detected in the filtrate after evaporative concentration, from which it is clear that the N6 was insoluble in HFIP and was fully crosslinked. 0.95 g was obtained in solid form.

The degree of swelling of the polyamide obtained was 54.

### Example 4

6.16 g (54.4 mmol) of ε-caprolactam, 0.035 g (0.193 mmol) of N-(2-oxoazepan-3-yl)propenamide and 0.9 g (1.127 mmol) of Bruggolen® C 10 (17% w/w ε-caprolactamate in ε-caprolactam) were mixed in the reactor at 140° C., and 0.41 g (0.83 mmol) of Bruggolen® C20 (80% w/w of blocked diisocyanate in ε-caprolactam) into the glass break-seal tube and heated at 140° C. On attainment of 140° C., the molten Bruggolen® C20 was injected into the molten mixture with the aid of a break-seal system, and the polymerization was left to stand for 20 minutes and then quenched by cooling the reactor in water (10° C.). This gave 7.6 g of nylon-6 in solid form.

1 g of the polymer obtained was poured while stirring into 50 ml of hexafluoroisopropanol (HFIP) at room temperature. After 10 h, a gel-like structure was obtained. After filtration, the polymer was only partly recovered on the filter, from which it is clear that the N6 was only partly insoluble in HFIP and was not fully crosslinked. 0.85 g was obtained in solid form.

### Comparative Example A

Synthesis of Linear Nylon-6

6.2 g of ε-caprolactam (54.8 mmol) and 0.89 g of Bruggolen C 10 (1.188 mmol) (Brüggemann Chemical, 17% w/w of sodium ε-caprolactamate in caprolactam) were introduced into the reactor, while 0.41 g of Bruggolen C20 (0.832 mmol) (Brüggemann Chemical, 80% w/w of blocked diisocyanate in ε-caprolactam) were introduced into the glass break-seal tube. After the system had settled at the polymerization temperature, the molten C20 was injected into the molten catalyst/monomer mixture through the break-seal, and the polymerization was allowed to continue for 20 minutes. The polymerization was quenched by cooling the reactor in water (10° C.). 7.4 g of nylon-6 were obtained (100% of the starting materials added).

1 g of the polymer obtained was poured while stirring into 50 mL of hexafluoroisopropanol (HFIP) at room temperature. After 5 minutes, the solution became transparent and homogeneous. After filtration, the polymer was recovered completely from the filtrate by removing the solvent to constant weight, from which it is clear that the linear N6 was fully soluble in HFIP.

### Comparative Example B

### Synthesis of Linear Nylon-6

The following representative synthesis method is used for the anionic polymerization of ε-caprolactam: 7.1 g of ε-caprolactam (62.7 mmol) and 0.3 g of Bruggolen C 10 (0.40 mmol) (Brüggemann Chemical, 17% w/w of sodium ε-caprolactamate in caprolactam), which corresponded to 0.6% mol/mol of caprolactam, were introduced into the reactor, while 0.1 g of Bruggolen C20 (0.24 mmol) (Brüggemann Chemical, 80% w/w of blocked diisocyanate in ε-caprolactam), which corresponded to 0.3% mol/mol of caprolactam, were introduced into the glass break-seal tube. After the system had settled at the polymerization temperature, the molten C20 was injected into the molten catalyst/monomer mixture through the break-seal, and the polymerization was allowed to continue for 20 minutes. The polymerization was quenched by cooling the reactor in water (10° C.).

7.5 g of nylon-6 were obtained (100% of the starting materials added).

1 g of the polymer obtained was poured while stirring into 50 mL of hexafluoroisopropanol (HFIP) at room temperature. After 5 minutes, the solution became transparent and homogeneous. After filtration, the polymer was recovered completely from the filtrate by removing the solvent to constant weight, from which it is clear that the linear N6 was fully soluble in HFIP.

### Comparative Example C

### Synthesis of Linear Nylon-6

See Macromolecules, volume 32, No. 23 (1999), 7726: Ex. PCL 9, p. 7727

Comparative Example B was repeated with polymerization at 155° C.; the resulting polymer was still soluble.

### Swelling Test on Crosslinked N6

The swelling state of the crosslinked N6 was characterized by the equilibrium swelling Q. Q is defined as the quotient of the (swollen) final volume V_{f} in HFIP and the (collapsed) starting volume Vᵢ, and can also be reported according to Eq. 1 as the quotient of the proportions by weight of the network in the starting and final gels, mᵢ and m_{f}, respectively, where ρ_{HFIP} (=1.452 g/mL) and ρ_{PA6} (1.14 g/mL) represent the density of the solvent and of the linear N6 obtained by anionic polymerization.

[symbol]

(Q=V₁f/V₁t=1+(m₁f/m₁ [symbol] −1)((₁N6/(₁HFIP)& eq (1))

1. A process for crosslinking polyamides found, which comprises reacting a compound of the general formula R¹R²C═CR³—X in which R¹, R² and R³ are each independently hydrogen or an organic radical with a lactam A at a temperature of (−30) to 150° C. and then reacting with a lactam B, a catalyst and an activator at a temperature of 40 to 240° C.

2. The process for crosslinking polyamide according to claim 1, wherein a compound of the general formula R¹R²C═CR³—X is reacted with a lactam A at a temperature of 0 to 80° C., and then reacted with a lactam B, a catalyst and an activator at a temperature of 70 to 180° C.

3. The process for crosslinking polyamide according to claim 1, wherein a compound of the general formula R¹R²C═CR³—X is reacted with a lactam A at a temperature of 20 to 50° C., and then reacted with a lactam B, a catalyst and an activator at a temperature of 100 to 170° C.

4. The process for crosslinking polyamide according to claim 1, wherein the molar ratio of the compound of the general formula R¹R²C═CR³—X to the lactam A is 0.01:1 to 100:1.

5. The process for crosslinking polyamide according to claim 1, wherein the molar ratio of the solvent A to the compound of the general formula R¹R²C═CR³—X is 200:1 to 0:1.

6. The process for crosslinking polyamide according to claim 1, wherein the molar ratio of the solvent A to the lactam A is 200:1 to 0.5:1.

7. The process for crosslinking polyamide according to claim 1, wherein the molar ratio of lactam B to lactam A is 1:1 to 10 000:1.

8. The process for crosslinking polyamide according to claim 1, wherein the molar ratio of lactam B to the catalyst is 1:1 to 10 000:1.

9. The process for crosslinking polyamide according to claim 1, wherein the molar ratio of activator to the catalyst is 0.01:1 to 10:1.
